(19) United States
(12) Patent Application Publication
(10) Pub. No.: US 2020/0003702 A1
(43) Pub. Date: Jan. 2, 2020

(54) NONDESTRUCTIVE INSPECTION APPARATUS AND NONDESTRUCTIVE INSPECTION METHOD

(71) Applicants: SHARP KABUSHIKI KAISHA, Sakai City (JP); NATIONAL INSTITUTE OF ADVANCED INDUSTRIAL SCIENCE AND TECHNOLOGY, TOKYO (JP)

(72) Inventors: HIROAKI MIYOSHI, Sakai City (JP); KAZUHIDE TOMIYASU, Sakai City (JP); WATARU NAKAMURA, Sakai City (JP); TAKESHI FUJIWARA, Tsukuba-shi (JP)

(21) Appl. No.: 16/454,635

(22) Filed: Jun. 27, 2019

(30) Foreign Application Priority Data
Jun. 29, 2018 (JP) 2018-125227

(51) Int. Cl. G01N 23/04

(52) U.S. Cl. CPC G01N 23/04; G01N 2223/646; G01N 2223/3303

(57) ABSTRACT

A nondestructive inspection apparatus includes an X-ray source, an imaging panel that detects an X-ray, and a shielding plate that shields the X-ray, and the imaging panel and the shielding plate have flexibility that allows to be curved.

### BACKGROUND

### 1. Field

The present disclosure relates to a nondestructive inspection apparatus and a nondestructive inspection method.

### 2. Description of the Related Art

A utility pole has been known as a pole for hanging an electric wire in the air. In recent years, a concrete pole is mainly used for the utility pole. The concrete pole is obtained by cylindrically arranging a large number of long reinforcing bars and then pouring concrete thereto to thereby integrally form the reinforcing bars and the concrete in a cylindrical shape. Nondestructive inspection is required for maintaining and managing such a concrete pole.

In a nondestructive inspection apparatus for a concrete defect, which is described in Japanese Unexamined Patent Application Publication No. 2002-82073, a neutron beam radiated from a neutron source is transmitted through a concrete block which is an object to be measured, and the transmitted neutron beam is made incident on a panel-type high-sensitivity neutron detector which is arranged so as to adhere closely to the object to be measured. In the nondestructive inspection apparatus for a concrete defect, which is described in Japanese Unexamined Patent Application Publication No. 2002-82073, whether there is a defect in the object to be measured is inspected by a signal obtained by the panel-type high-sensitivity neutron detector.

An example in which a utility pole having a curved surface is inspected by using a nondestructive inspection apparatus including a conventional flat panel detector will be described with reference to FIG. 9. A nondestructive inspection apparatus 110 includes an X-ray source 111, an imaging panel 114 which is a flat panel detector, and a shielding plate 115. In a utility pole 102, a plurality of reinforcing bars 103 are buried in a concrete part 104 having a frame shape. Note that, FIG. 9 illustrates a cross-sectional view of the utility pole 102, which is taken along a direction orthogonal to a major axis.

In order to capture an X-ray transmission image of an inside of the utility pole 102 by the nondestructive inspection apparatus 110, the X-ray source 111 and the imaging panel 114 are arranged with the utility pole 102 interposed therebetween. Moreover, the shielding plate 115 that covers the imaging panel 114 is provided so that leakage X-rays radiated from the X-ray source 111 are minimized the surrounding environment.

The X-ray 119 radiated from the X-ray source 111 is radially transmitted through the utility pole 102 and detected by the imaging panel 114. In the utility pole 102, the X-ray 119 is transmitted through the concrete part 104 and is not transmitted through the reinforcing bars 103, so that it is possible to observe a state of the reinforcing bars 103 in the utility pole 102 by measuring an amount of the X-ray detected by the imaging panel 114.

However, the imaging panel 114 and the shielding plate 115 are not configured to be curved while an outer surface of the utility pole 102 is curved. Therefore, as the shielding plate 115, in addition to a bottom part that covers a rear surface (the backside of X-ray detection surface) of the imaging panel 114 having a plate shape, a side part that stands from the bottom part so as to surround the light detecting surface of the imaging panel 114 is required to be provided. A size of the nondestructive inspection apparatus 110 is thus increased. In particular, the shielding plate 115 consists of heavy metal such as lead for shielding the X-ray 119, so that an increase of a size of the shielding plate 115 also causes an increase in a weight.

Moreover, since the X-ray detection surface of the imaging panel 114 is not curved but flat while the outer surface of the utility pole 102 is curved, a distance between the light detecting surface of the imaging panel 114 and the utility pole 102 varies depending on a position in the surface of the imaging panel 114. For example, in a path from the X-ray source 111 to the imaging panel 114, which passes through a reinforcing bar 103a in a vicinity of a center of the imaging panel 114, it is assumed that a distance from the X-ray source 111 to the reinforcing bar 103a is d101 and a distance from the reinforcing bar 103a to the imaging panel 114 is d102. Moreover, in a path from the X-ray source 111 to the imaging panel 114, which passes through a reinforcing bar 103b in a vicinity of an edge of the imaging panel 114, it is assumed that a distance from the X-ray source 111 to the reinforcing bar 103b is d103 and a distance from the reinforcing bar 103b to the imaging panel 114 is d104. Then, the distance d104 is longer than the distance d102. As a result, an image obtained by inspecting the utility pole 102 by the imaging panel 114 becomes more blurred as being closer to the edge, and deterioration in inspection accuracy is caused. The same is applied to a case of using the panel-type high-sensitivity neutron detector which is described in Japanese Unexamined Patent Application Publication No. 2002-82073 and is not curved.

An aspect of the disclosure achieves a nondestructive inspection apparatus that is light and obtains a high-definition image and a nondestructive inspection method that uses the nondestructive inspection apparatus.

### SUMMARY

In order to cope with the aforementioned problems, a nondestructive inspection apparatus according to an aspect of the disclosure includes: a radiation source; an imaging panel that detects a radiation emitted from the radiation source and transmitted through an inspection target; and a shielding plate that is arranged so as to cover the backside of imaging panel and shields the radiation emitted from the imaging panel, in which the imaging panel and the shielding plate have flexibility that allows to be curved.

In order to cope with the aforementioned problems, a nondestructive inspection method according to an aspect of the disclosure is a nondestructive inspection method that uses a nondestructive inspection apparatus including a radiation source, an imaging panel that detects a radiation emitted from the radiation source and transmitted through an inspection target, and a shielding plate that is arranged so as to be overlapped with the imaging panel on a side opposite to a side facing the radiation source and shields the radiation emitted from the imaging panel, and the method includes arranging the imaging panel and the shielding plate that are overlapped with each other and the radiation source with the inspection target interposed therebetween, in which at the arranging, the imaging panel and the shielding plate each of which has flexibility are further arranged so as to be curved along a curved surface of the inspection target.

### BRIEF DESCRIPTION OF THE DRAWINGS

FIG. 1 is a cross-sectional view of a nondestructive inspection apparatus according to Embodiment 1;

FIG. 2 is a side view of the nondestructive inspection apparatus according to Embodiment 1;

FIG. 3 is a view illustrating a state where a radiation source unit, an imaging panel, and a shielding plate are arranged in the nondestructive inspection apparatus according to Embodiment 1 so that a reinforcing bar inside of an utility pole and the emitting point of the radiation source unit are overlapped with each other;

FIG. 4 is a view illustrating a state where the radiation source unit, the imaging panel, and the shielding plate are rotated counterclockwise by 90° from a state of the nondestructive inspection apparatus, which is illustrated in FIG. 1;

FIG. 5 is a cross-sectional view of a nondestructive inspection apparatus according to Embodiment 2;

FIG. 6 is a view illustrating a state where the nondestructive inspection apparatus illustrated in FIG. 5 is rotated counterclockwise by a constant angle;

FIG. 7 is a cross-sectional view of a nondestructive inspection apparatus according to Embodiment 3;

FIG. 8 is a side view of a nondestructive inspection apparatus according to Embodiment 4; and

FIG. 9 is a view illustrating a state where a utility pole is inspected by using a conventional nondestructive inspection apparatus.

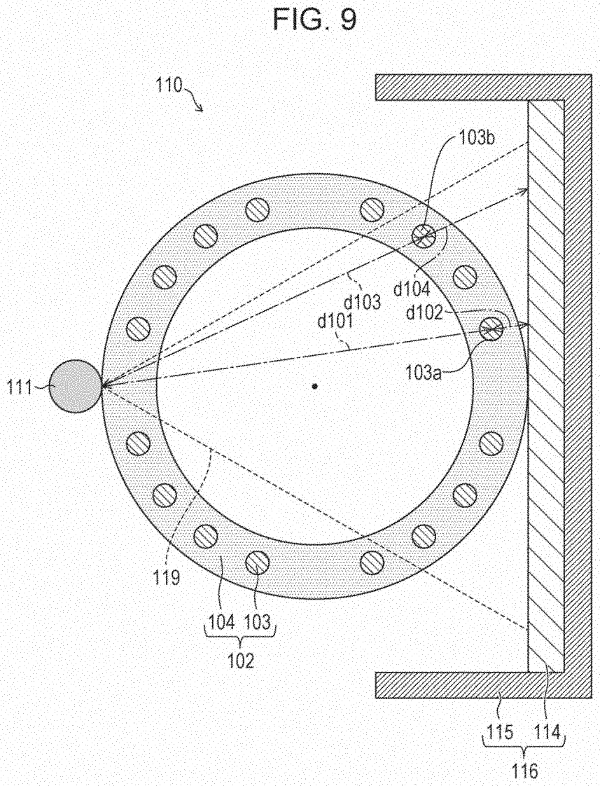

### DESCRIPTION OF THE EMBODIMENTS

### Embodiment 1

### Structures of Nondestructive Inspection Apparatus 10 and Utility Pole 2

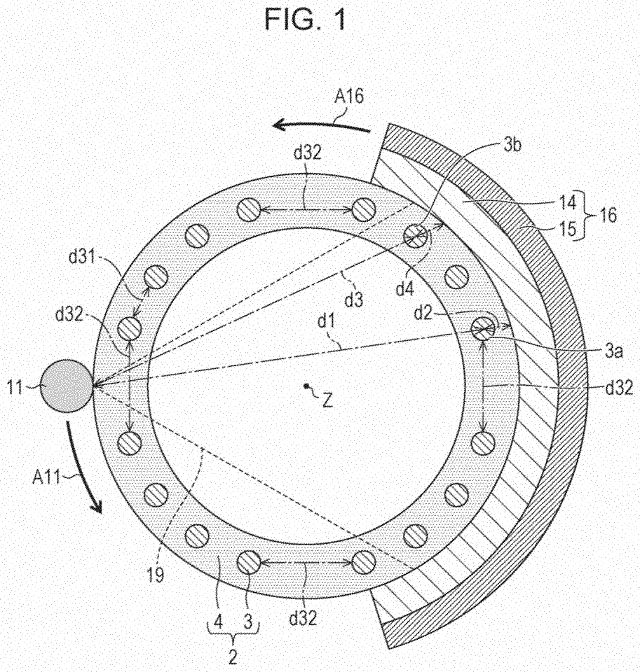

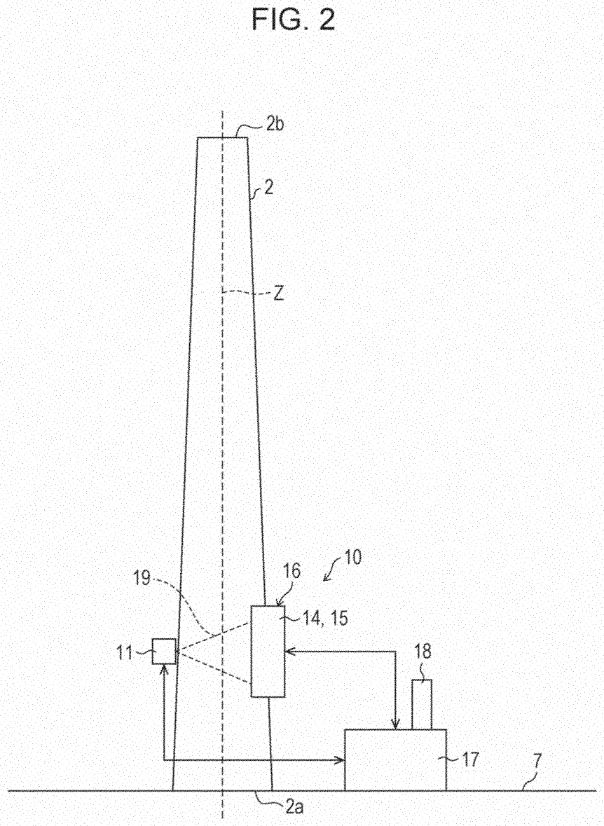

FIG. 1 is a cross-sectional view of a nondestructive inspection apparatus 10 according to Embodiment 1. FIG. 2 is a side view of the nondestructive inspection apparatus 10 according to Embodiment 1. A section of a utility pole 2, which is illustrated in FIG. 1, is taken along a direction orthogonal to a central axis Z of the utility pole 2, which is illustrated in FIG. 2.

The nondestructive inspection apparatus 10 is an apparatus for nondestructively inspecting an inspection target. The nondestructive inspection apparatus 10 includes an X-ray source (radiation source) 11, an imaging device 16, a control unit (image acquisition unit) 17, and a display unit 18. The imaging device 16 includes an imaging panel 14 and a shielding plate 15 each of which has flexibility that allows to be curved.

The utility pole 2 is an example of the inspection target for which a nondestructive inspection is executed by the nondestructive inspection apparatus 10. The utility pole 2 is erected on a ground 7. The utility pole 2 is extended along the central axis Z orthogonal to the ground 7. In the present embodiment, the utility pole 2 has a columnar shape, an outer diameter of which being gradually reduced being closer to a head part 2b from a base part 2a that is in contact with the ground 7. Note that, the utility pole 2 may have a round columnar shape, an outer diameter of which being the same throughout from the base part 2a to the head part 2b.

The utility pole 2 has a shape an outer surface of which is curved. The utility pole 2 is a reinforced concrete structure that includes a concrete part 4 whose cross-section taken along the direction orthogonal to the central axis Z has a circular frame shape and reinforcing bars 3 which are buried in the concrete part 4. A plurality of reinforcing bars 3 are arranged so as to surround a periphery of the central axis Z and are extended along the central axis Z. In the present embodiment, reinforcing bar groups each of which has a plurality of reinforcing bars 3 that are adjacent to each other at a short distance d31 are arranged in the utility pole 2 at a distance d32 in a rotationally symmetrical manner around the central axis Z. In an example illustrated in FIG. 1, the reinforcing bar groups each of which is composed of the plurality of reinforcing bars 3 adjacent to each other at the distance d31 are arranged at the distance d32 in a rotated manner by 90° around the central axis Z.

The X-ray source 11 irradiates the inspection target with a radiation that is transmitted through the inspection target. In the present embodiment, the X-ray source 11 performs irradiation with an X-ray 19 that Is transmitted through the utility pole 2 serving as the Inspection target. Note that, the radiation source may be a source that performs radiation not with the X-ray but with another radiation such as a gamma ray or a neutron beam in accordance with a type of the inspection target, an inspection mode, and the like.

The imaging panel 14 is a flat panel detector which has flexibility that allows to be curved. The imaging panel 14 detects the X-ray 19 that has been emitted from the X-ray source 11 and transmitted through the utility pole 2. In a case where the X-ray source 11 is a radiation source that emits a radiation other than the X-ray 19, the imaging panel 14 may be a flat panel detector that is able to detect a radiation type radiated by the radiation source. The imaging panel 14 is provided with a light detecting unit which pixels are arranged in a matrix manner on a basal plate that is formed of, for example, a resin having flexibility that allows to be curved.

In each of the pixels of the imaging panel 14, for example, a photodiode that causes an electric current according to an amount of a detected radiation to flow, a pixel circuit that controls drive of the photodiode, and the like are arranged. This makes it possible to output, from each of the pixels, an electric signal according to the detected radiation amount to the control unit 17.

The shielding plate 15 is a plate-shaped member which has flexibility that allows to be curved. The shielding plate 15 shields the X-ray 19 emitted by the X-ray source 11. The shielding plate 15 is arranged so as to be overlapped with the imaging panel 14 on a side opposite to a side facing the X-ray source 11 to thereby shield the X-ray 19 emitted from the imaging panel 14 (in other words, transmitted through the imaging panel 14). In the case where the X-ray source 11 is a radiation source that emits a radiation other than the X-ray 19, the shielding plate 15 may be able to shield a type of radiation radiated by the radiation source. The shielding plate 15 includes a heavy metal such as lead, which is in a plate shape, for example.

The control unit 17 controls crave of the X-ray source 11, the imagine panel 14 of the imagine device 16, and the display unit 18. Moreover, the control unit 17 acquires the electric signal output by the imaging panel 14 that has detected the X-ray 19 and generates, from the electric signal, an image of the utility pole 2 through which the X-ray 19 has been transmitted. It is possible to constitute the control unit 17 by one or a plurality of computers. The d splay unit 18 is a display on which the image obtained by the control unit 17 is displayed.

### Arranging and Imaging Methods of Nondestructive Inspection Apparatus 10

As illustrated in FIGS. 1 and 2, in a case where a nondestructive inspection of the utility pole 2 is performed with use of the nondestructive inspection apparatus 10, first, the X-ray source 11 and the imaging panel 14 and the shielding plate 15, the imaging panel 14 and the shielding plate 15 being overlapped with each other, are arranged with the utility pole 2 interposed therebetween (arranging step). Furthermore, at the arranging step, the imaging panel 14 and the shielding plate 15 each of which has flexibility are arranged on the outer surface of the utility pole 2 so as to be curved along the curved surface of the utility pole 2.

After the arranging step, the X-ray source 11 and the imaging panel 14 are driven, and an image of an inside of the utility pole 2 is captured (imaging step). Specifically, X-rays 19 emitted by the X-ray source 11 are radially transmitted through the utility pole 2, and the X-rays 19 transmitted through the utility pole 2 are detected by the imaging panel 14. The imaging panel 14 outputs, to the control unit 17, an electric signal according to a radiation amount of each of the detected X-rays 19. The control unit 17 thereby generates, from the electric signal acquired from the imaging panel 14, the image of the inside of the utility pole 2 through which the X-rays 19 are transmitted. Thus, it is possible to inspect whether there is a defect in the inside of the utility pole 2. The control unit 17 may cause the display unit 18 to display the generated image.

In the utility pole 2, the X-ray 19 is transmitted through the concrete part 4 but is not transmitted through the reinforcing bar 3, so that the control unit 17 is able to acquire an image, which indicates whether there is a defect, of the reinforcing bar 3 in the utility pole 2, by measuring the radiation amount of the X-ray 19 detected by the imaging panel 14.

Here, the imaging panel 14 and the shielding plate 15 have flexibility that allows to be curved, as described above. Thus, even when a shape of the utility pole 2 is a curved shape, the imaging panel 14 and the shielding plate 15 are able to be curved along the shape of the utility pole 2. Each of the imaging panel 14 and the shielding plate 15 is curved so that a surface on a side on which the X-ray source 11 is arranged has a recessed shape. Therefore, even when the X-ray source 11 radially emits the X-rays 19, the X-rays 19 are able to be received by the surface of the shielding plate 15, which is curved so as to have the recessed shape. It is thereby possible to shield the X-rays 19, which is emitted by the X-ray source 11, so as not to leak to a periphery of the imaging panel 14 or a rear side thereof.

As above, since each of the imaging panel 14 and the shielding plate 15 has flexibility and is able to be curved along the shape of the outer surface of the utility pale 2, it is possible to shorten a distance between the utility pole 2 and the imaging panel 14 and a distance between the imaging panel 14 and the shielding plate 15, differently from a case where an imaging panel and a shielding plate which do not have flexibility are used.

Specifically, for example, in a path from the X-ray source 11 to the imaging panel 14, which passes through a reinforcing bar 3a in a vicinity of a center of the imaging panel 14, it is assumed that a distance from the X-ray source 11 to the reinforcing bar 3a is d1 and a distance from the reinforcing bar 3a to the imaging panel 14 is d2. Moreover, in a path from the X-ray source 11 to the imaging panel 14, which passes through a reinforcing bar 3b in a vicinity of an edge of the imaging panel 14, it is assumed that a distance from the X-ray source 11 to the reinforcing bar 3b is d3 and a distance from the reinforcing bar 3b to the imaging panel 14 is d4. Then, it is possible to set the distance d2 and the distance d4 to be almost the same, thus making it possible to shorten a distance between the imaging panel 14 and the outer surface of the utility pole 2 compared to a case where an imaging panel which is not flexible is used. Additionally, it is possible to shorten the distance between the imaging panel 14 and the shielding plate 15 compared to a case where a shielding plate which is not flexible is used.

Therefore, the shielding plate 15 may have approximately the same area as that of the imaging panel 14, and a size thereof is able to be reduced, thus making it possible to obtain the nondestructive inspection apparatus 10 a size and a weight of which are reduced. In particular, since the shielding plate 15 includes the heavy metal such as lead, an effect of weight reduction caused by size reduction is great.

A gap may be provided between the utility pole 2 and the imaging panel 14 and between the imaging panel 14 and the shielding plate 15, or the imaging panel 14 may be arranged so that a light detecting surface thereof adheres closely to the outer surface of the utility pole 2, and, furthermore, the shielding plate 15 may be arranged so as to adhere closely to a rear surface (surface opposite to the light detecting surface) of the imaging panel 14. It is thereby possible to further shorten the distance between the utility pole 2 and the imaging panel 14 and the distance between the imaging panel 14 and the shielding plate 15, thus making it possible to further reduce the size of the shielding plate 15.

in addition, since it is possible to set the distance d2 and the distance d4 to be almost the same as described above, it is possible to avoid that the distance to the outer surface of the utility pole 2 varies depending on a position in the surface of the imaging panel 14. Therefore, it is possible to prevent a fault such that, in an image captured by the imaging panel 14, an image in a region near an edge becomes more blurred than an image in a region near a center. That is, with use of the imaging panel 14, it is possible to capture an image of the inside of the utility pole 2 so as to obtain a clear image in any region of the surface. This makes it possible to improve inspection accuracy as to whether there is a detect in the inside of the utility pole 2.

In this manner, with use of the nondestructive inspection apparatus 10, it is possible to reduce the size and the weight compared to those of a structure in which neither an imaging panel nor a shielding plate is curved. In addition, it is possible to suppress variations of the distance to the utility pole 2 in the surface of the imaging panel 14, so that a high-definition image is able to be obtained over the whole surface of the imaging panel 14.

After the imaging step, as illustrated in FIG. 2, the X-ray source 11, the imaging panel 14, and the shielding plate 15 are relatively moved with respect no the utility pole 2 in a major axis direction (extending direction of the central axis Z) of the utility pole 2 (relatively moving step). After the relative movement, the arranging step and the imaging step are performed again to thereby perform imaging successively in the major axis direction (extending direction of the central axis Z) of the utility pole 2.

Note that, an outer diameter of the utility pole 2 is gradually reduced as being closer no the head part 2b from the base part 2a. Thus, a curvature of the utility pole 2 to be inspected varies in accordance with a position on the central axis Z. However, the nondestructive inspection apparatus 10 includes the imaging panel 14 and the shielding plate 15 that have flexibility and are able to be curved along the curved surface of the utility pole 2. It is therefore possible to arrange the imaging panel 14 and the shielding plate 15 in accordance with the curvature of the utility pole 2 even when the curvature of the utility pole 2 varies before and after the relative movement. Thereby, it is possible to inspect the utility pole 2 along the major axis direction.

Moreover, the X-ray source 11, the imaging panel 14, and the shielding plate 15 may be moved relatively to the utility pole 2 so that regions imaged by the imaging panel 14 before and after the relative movement are not overlapped with each other. Thereby, it, is possible to speedily perform imaging from the base part 2a of the utility pole 2 to the head part 2b thereof.

Note that, the relative movement of the X-ray source 11, the imaging panel 14, and the shielding plate 15 with respect to the utility pole 2 may be performed by a worker, or may be performed by a robot by providing the nondestructive inspection apparatus 10 with the robot.

Moreover, a rotating step at, which the X-ray source 11, the imaging panel 14, and the shielding plate 15 are rotated around the central axis Z of the utility pole 2 may be further provided after the imaging step and before the relatively moving step. Specifically, arrangement, photographing, and rotation of the X-ray source 11, the imaging panel 14, and the shielding plate 15 may be repeated so that an image of an entirety of the inside of the utility pole 2 is able to be obtained by, for example, rotating the X-ray source 11 in a counterclockwise direction, which is indicated with an arrow A11, by a constant angle (rotating step) and rotating the imaging panel 14 and the shielding plate 15 in the counterclockwise direction, which is indicated with an arrow A16, by the constant angle each time photographing is performed, as illustrated in FIG. 1. Then, the control unit 17 may restructure the image of the inside of the utility pole 2 on the basis of the plurality of images obtained by plural times of imaging. Thereby, it is possible to detect a defect which does not appear in an image when the utility pole 2 is imaged only from a specific angle. Note that, the rotation of the X-ray source 11, the Imaging panel 14, and the shielding plate 15 may be performed by a worker, or may be performed by a robot by providing the nondestructive inspection apparatus 10 with the robot.

When the X-ray source 11, the imaging panel 14, and the shielding plate 15 are arranged again after the rotation, the X-ray source 11, the imaging panel 14, and the shielding plate 15 may be arranged again so that relative positions of the X-ray source 11 and the imaging panel 14 are the same before and after the rotation. Thereby, it is possible to make an image in the restructured image, which is obtained by restructuring the image of the inside of the utility pole 2 by the control unit 17 on the basis of the plurality of images, clear.

### Example 1 of Arranging and Imaging Method of Nondestructive Inspection Apparatus 10

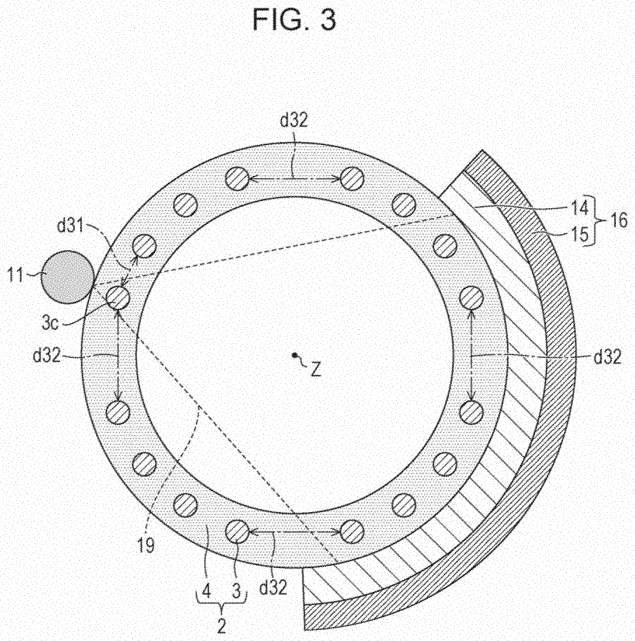

FIG. 3 is a view illustrating a state where the X-ray source 11, the imaging panel 14, and the shielding plate 15 are arranged so that a reinforcing bar 3c in the inside of the utility pole 2 and an emitting surface of the X-ray source 11 are overlapped with each other. The X-rays 19 emitted from the X-ray source 11 are radially spread from the X-ray source 11, transmitted through the inside of the utility pole 2, and detected by the imaging panel 14. Therefore, an image of the reinforcing bar 3c which is overlapped with the emitting surface of the X-ray source 11 is enlarged to be projected on and imaged by the imaging panel 14 compared to those of the reinforcing bars 3 which are overlapped with the light detecting surface of the imaging panel 14. As a result, an image of each of the reinforcing bars 3 which is overlapped with the light detecting surface of the imaging panel 14 is overlapped with the enlarged image of the reinforcing bar 3c, so that it is difficult to obtain a clear image in some cases. As a result, a determination of an inspection as to whether there is a defect of the reinforcing bar 3 is not able to be correctly made in some cases.

Then, as illustrated in FIG. 1, at the above-described arranging step, the X-ray source 11 may be arranged so that the emitting surface faces a gap between the plurality of reinforcing bars 3. Thereby, the X-rays 19 emitted from the X-ray source 11 progress inside the utility pole r from the gap between the reinforcing bars 3, are radially spread to be radiated to the reinforcing bars 3 overlapped with the light detecting surface of the imaging panel 14, and are detected by the imaging panel 14. This makes it possible to obtain an image including a clear image of each of the reinforcing bars 3 which are overlapped with the light detecting surface of the imaging panel 14. As a result, it is possible to correctly make the determination of the inspection as to whether there is a defect of the reinforcing bar 3, even though the control unit 17 does not generate an image restructured from a plurality of images obtained by imaging each of the reinforcing bars 3, which is overlapped with the light detecting surface of the imaging panel 14 from a different angle.

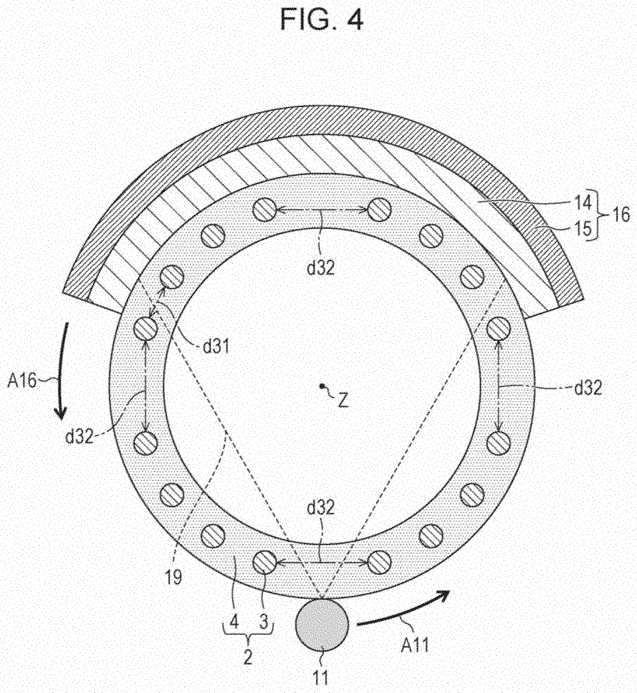

FIG. 4 is a view illustrating a state where the X-ray source 11, the imaging panel 14, and the shielding plate 15 which are illustrated in FIG. 1 are rotated counterclockwise by 90°. As described above, the X-ray source 11, the imaging panel 14, and the shielding plate 15 may go round an outer circumference of the utility pole 2 by being rotated by a constant angle each time. In this case, the X-ray source 11 and the imaging panel 14 may perform photographing at every rotation of the constant angle to thereby image entirely the reinforcing bars 3 in the inside of the utility pole 2, and the control unit 17 may restructure, from the plurality of images, the image including the images of the entire reinforcing bars 3 in the inside of the utility pole 2.

For example, the reinforcing bars 3 illustrated in FIG. 1 are arranged so as to be arrayed circularly with the central axis Z as a center, and four places at each of which the reinforcing bars 3 are arranged at the distance d32 which is longer than the distance d31 are provided so as to be 90° rotationally symmetric.

Then, as illustrated in FIG. 1, arrangement is performed so that the X-ray source 11 is overlapped with the gap between the reinforcing bars 3 between which the distance d32 is provided, and imaging is performed. Next, as illustrated in FIG. 4, from the state illustrated in FIG. 1, by rotating the X-ray source 11, the imaging panel 14, and the shielding plate 15 in the counterclockwise direction (direction indicated by the arrows A11 and A16) by 90° with the central axis Z as the center, arrangement is performed so that, the X-ray source 11 is overlapped with the gap between the reinforcing bars 3 between which the distance d32 is provided, and imaging is performed. Thereafter, from the state illustrated in FIG. 4, rotating the X-ray source 11, the imaging panel 14, and the shielding plate 15 in the counterclockwise direction (direction indicated by the arrows A11 and A16) by 90° with the central axis Z as the center, arrangement is performed so that the X-ray source 1 is overlapped with the gap between the reinforcing bars 3 between which the distance d32 is provided, and imaging is performed. Furthermore, by rotating the X-ray source 11, the imaging panel 14, and the shielding plate 15 in the counterclockwise direction by 90° with the central axis Z as the center, arrangement is performed so that the X-ray source 11 is overlapped with the gap between the reinforcing bars 3 between which the distance d32 is provided, and imaging is performed.

Thereby, the X-ray source 11, the imaging panel 14, and the shielding plate 15 go round the outer circumference of the utility pole 2. When the X-ray source 11 and the imaging panel 14 successively image the inside of the utility pole 2 at every rotation, it is possible to obtain the image including the clear images of the reinforcing bars 3 in the entire inside of the utility pole 2.

Note that, a rotational direction of the X-ray source 11, the imaging panel 14, and the shielding plate 15 may not be the counterclockwise direction but may be a clockwise direction which is opposite. Moreover, although description has been given in the above such that the X-ray source 11, the imaging panel 14, and the shielding plate 15 go round the outer circumference of the utility pole 2, the X-ray source 11, the imaging panel 14, and the shielding plate 15 may be rotated around the outer circumference of the utility pole 2 by any angle such as halfway round.

To specify a position of the gap between the reinforcing bars 3, at which the X-ray source 11 is arranged, for example, a worker may refer to a design drawing of the utility pole 2, a view illustrating an install direction of the utility pole 2, or the like so that the worker specifies the position. Alternatively, the worker may also specifies the position while checking an image of the inside of the utility pole 2, which is imaged and displayed on the display unit 18.

### Embodiment 2

Embodiment 2 of the disclosure will be described below. Note that, for convenience of the description, the same reference signs will be assigned to members having the same functions as those of the members described in Embodiment 1, and description thereof will not be repeated.

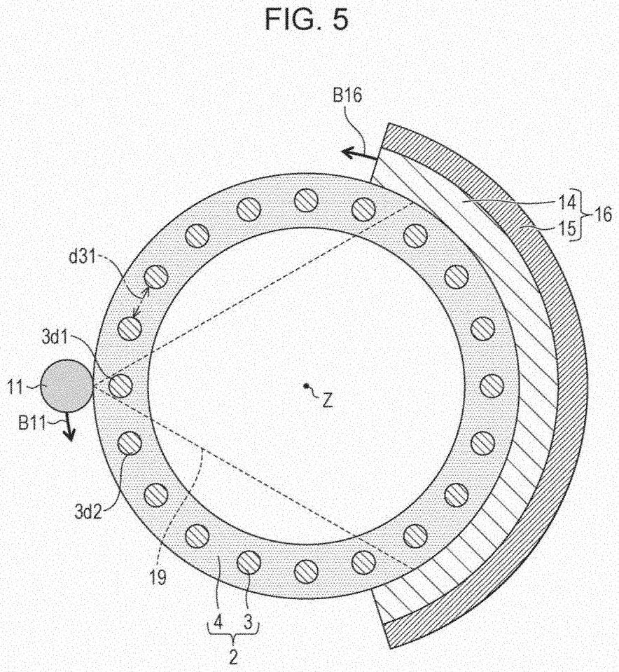

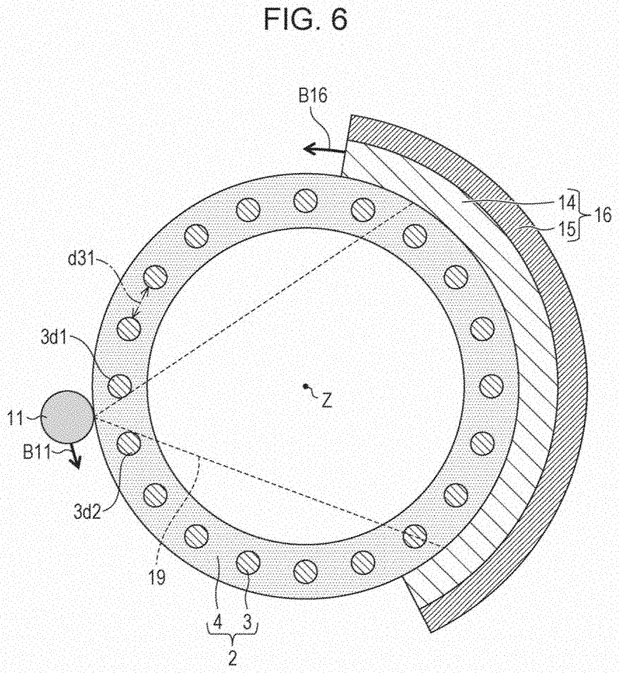

FIG. 5 is a cross-sectional view of the nondestructive inspection apparatus 10 according to Embodiment 2. FIG. 6 is a view illustrating a state where the nondestructive inspection apparatus 10 illustrated in FIG. 5 is rotated counterclockwise by a constant angle. As illustrated in FIGS. 5 and 6, in the present embodiment, it is assumed that the reinforcing bars 3 are arranged at equal pitch of the distance d31, which is a narrow interval, in the inside of the utility pole 2. In this manner, there are some cases where the reinforcing bars 3 in the utility pole 2 are arranged at equal pitch over the circumference.

Also in such a case, first, the X-ray source 11 and the imaging panel 14 and the shielding plate 15, the imaging panel 14 and the shielding plate 15 being overlapped with each other, are arranged with the utility pole 2 interposed therebetween (arranging step), similarly to Embodiment 1. Furthermore, the imaging panel 14 and the shielding plate 15 each of which has flexibility are arranged on the outer surface of the utility pole 2 so as to be curved along the curved surface of the utility pole 2 at the arranging step. After the arranging step, the X-ray source 11 and the imaging panel 14 are driven to capture an image of the inside of the utility pole 2 (imaging step). Note that, as a reinforcing bar 3d1 illustrated in FIG. 5, there are some cases where the reinforcing bar 3 is overlapped with the emitting surface of the X-ray source 11 at a time of imaging. An image of the reinforcing bar 3d1 which is overlapped with the emitting surface of the X-ray source 11 in this manner is photographed in an enlarged manner, so that it is difficult to obtain a clear image.

Next, the X-ray source 11, the imaging panel 14, and the shielding plate 15 are rotated in the counterclockwise direction (direction indicated by arrows B11 and B16) by a constant angle with the central axis Z as a center so that a state illustrated in FIG. 5 is changed into the state illustrated in FIG. 6 (rotating step), arrangement is performed so that the emitting surface of the X-ray source 11 is overlapped with a gap between reinforcing bars 3d1 and 3d2 which are adjacent to each other, and imaging is performed. In an image captured by the imaging panel 14 in the state illustrated in FIG. 6, the image of the reinforcing bar 3d1, which is enlarged, is not included or, even when being included, is included only in a part of the entire image. Therefore, the control unit 17 is able to acquire an image that includes a clear image of each of the reinforcing bars 3, which are overlapped with the imaging panel 14, by compositing (restructuring) images captured before and after the rotation (the image captured in the state illustrated in FIG. 5 and the image captured in the state illustrated in FIG. 6) while removing the enlarged image of the reinforcing bar 3d1.

At this time, the rotation angle or a moving distance of the X-ray source 11, the imaging panel 14, and the shielding plate 15, which is on the outer circumferential surface of the utility pole 2 and accompanies the rotation, may be stored in a storage unit or the like in the control unit 17. By calculating an imaging range of the utility pole 2 from the images before and after the rotation and from the rotation angle or the moving distance and, for example, displaying the resultant on the display unit 18, the control unit 17 is able to present the resultant to a worker.

The X-ray source 11, the imaging panel 14, and the shielding plate 15 are rotated on the outer circumferential surface of the utility pole 2 by the constant angle and moves around the utility pole 2. Then, the X-ray source 11 and the imaging panel 14 successively inspect the inside of the utility pole 2 at every rotation, and thereby an image including fine images of the reinforcing bars 3 in the entire inside of the utility pole 2 are able to be obtained.

The angle by which the X-ray source 11, the imaging panel 14, and the shielding plate 15 are rotated may be an angle which allows a distance by which the X-ray source 11, the imaging panel 14, and the shielding plate 15 move on the outer circumferential surface of the utility pole 2 to be a distance different from the distance d31 that is the pitch between the reinforcing bars 3. This makes it possible to more reliably remove, by using the plurality of images, the image of the reinforcing bar 3 which is overlapped with the emitting surface of the X-ray source 11 and is thereby imaged in the enlarged manner.

### Embodiment 3

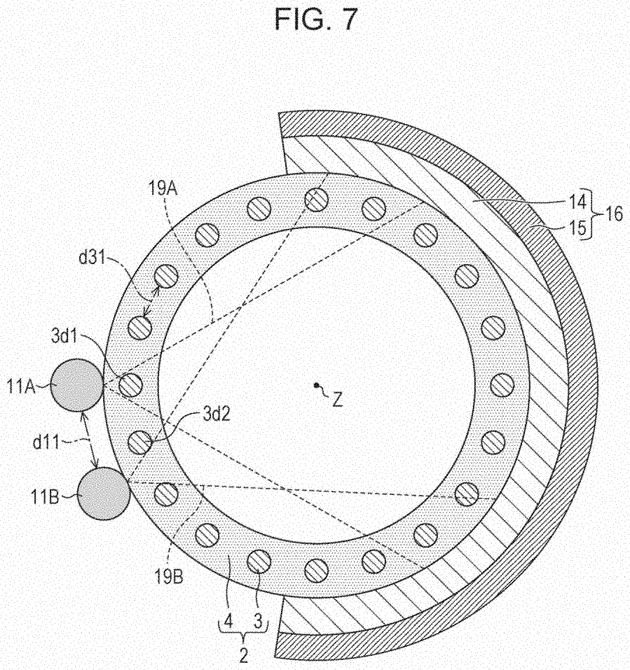

Embodiment 3 of the disclosure will be described below. Note that, for convenience of the description, the same reference signs will be assigned to members having the same functions as those of the members described in Embodiment 1 or 2, and description thereof will not be repeated. FIG. 7 is a cross-sectional view of the nondestructive inspection apparatus 10 according to Embodiment 3. As illustrated in FIG. 7, the nondestructive inspection apparatus 10 may include a first X-ray source (first radiation source) 11A and a second X-ray source (second radiation source) 11B that are a plurality of X-ray sources.

Also in the present embodiment, first, the imaging panel 14 and the shielding plate 15 which are overlapped with each other and the first X-ray source 11A and the second X-ray source 11B are arranged with the utility pole 2 interposed therebetween (arranging step). Furthermore, at the arranging step, the imaging panel 14 and the shielding plate 15 each of which has flexibility are arranged on the outer surface of the utility pole 2 so as to be curved along the curved surface of the utility pole 2. After the arranging step, the first X-ray source 11A, the second X-ray source 11B, and the imaging panel 14 are driven to capture an image of the inside of the utility pole 2 (imaging step).

Specifically, X-rays 19A emitted from the first X-ray source 11A are radially transmitted through the utility pole 2, and the X-rays 19A transmitted through the utility pole 2 are detected by the imaging panel 14. Moreover, X-rays 19B emitted from the second X-ray source 11B are radially transmitted through the utility pole 2, and the X-rays 19B transmitted through the utility pole 2 are detected by the imaging panel 14. Then, the imaging panel 14 outputs, to the control unit 17, an electric signal according to a radiation amount of the detected X-rays 19A and 19B. The control unit 17 thereby acquires an image of the inside of the utility pole 2, through which the X-rays 19A and 19B are transmitted, from the electric signal acquired from the imaging panel 14, thus making it possible to inspect whether there is a defect in the inside of the utility pole 2.

For example, even when the reinforcing bar 3d1 is overlapped with an emitting surface of the first X-ray source 11A, it is possible to arrange an emitting surface of the second X-ray source 11B so as not to be overlapped with the reinforcing bar 3d1, the reinforcing bar 3d2, or the other reinforcing bars 3. Thereby, the control unit 17 is able to obtain an image including clear images of the reinforcing bars 3, which are overlapped with the imaging panel 14, by compositing (restructuring) an image which is captured with use of the X-rays 19A emitted from the first X-ray source 11A and an image which is captured with use of the X-rays 19B emitted from the second X-ray source 11B while removing the image of the reinforcing bar 3d1. Thereby, the first X-ray source 11A, the second X-ray source 11B, the imaging panel 14, or the shielding plate 15 may not be rotated in order to remove the enlarged image of the reinforcing bar 3d1. Note that, to capture an entire image of the inside of the utility pole 2, imaging may be performed by rotating the first X-ray source 11A, the second X-ray source 11B, the imaging panel 14, and the shielding plate 15 for rounding the outer circumference of the utility pole 2.

### Embodiment 4

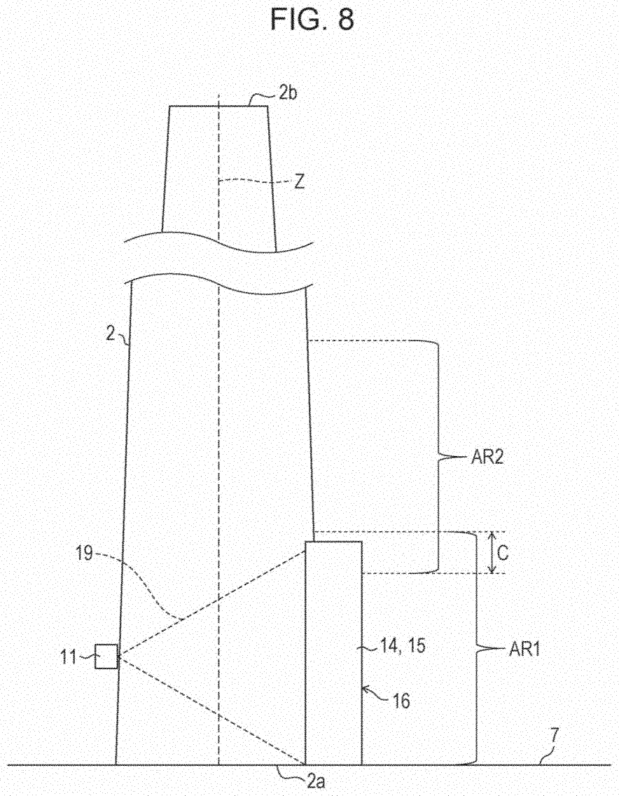

Embodiment 4 of the disclosure will be described below. Note that, for convenience of the description, the same reference signs will be assigned to members having the same functions as those of the members described in Embodiment 1, 2, or 3, and description thereof will not be repeated. FIG. 8 is a side view of the nondestructive inspection apparatus 10 according to Embodiment 4.

When the X-ray source 11, the imaging panel 14, and the shielding plate 15 are relatively moved in the major axis direction of the utility pole 2, by relatively moving the imaging panel 14 with respect to the utility pole 2 so as to be overlapped with a partial area C in an imaging area AR1 of the utility pole 2, which is imaged by the imaging panel 14 before the relative movement, imaging of a next imaging area AR2 after the relative movement may be performed. This is because it is thereby possible to suppress an inspection omission when the X-ray source 11, the imaging panel 14, and the shielding plate 15 are relatively moved in the major axis direction of the utility pole 2.

The disclosure is not limited to each of the embodiments described above, and may be modified in various manners within the scope indicated in the claims and an embodiment achieved by appropriately combining techniques disclosed in each of different embodiments is also encompassed in the technical scope of the disclosure. Further, by combining the techniques disclosed in each of the embodiments, a new technical feature may be formed.

The present disclosure contains subject matter related to that disclosed in Japanese Priority Patent Application JP 2018-125227 filed in the Japan Patent Office on Jun. 29, 2018, the entire contents of which are hereby incorporated by reference.

It should be understood by those skilled in the art that various modifications, combinations, sub-combinations and alterations may occur depending on design requirements and other factors insofar as they are within. the scope of the appended claims or the equivalents thereof.

What is claimed is:

1. A nondestructive inspection apparatus comprising:
a radiation source;
an imaging panel that detects a radiation emitted from the radiation source and transmitted through an inspection target; and
a shielding plate that is arranged so as to be overlapped with the imaging panel on a side opposite to a side facing the radiation source and shields the radiation emitted from the imaging panel, wherein
the imaging panel and the shielding plate have flexibility that allows to be curved.

2. The nondestructive inspection apparatus according to claim 1, further comprising:
an image acquisition unit that acquires an electric signal output from the imaging panel which detected the radiation and generates, from the electric signal, an image of the inspection target through which the radiation is transmitted.

3. The nondestructive inspection apparatus according to claim 2, wherein
the radiation source and the imaging panel image the inspection target plural times from different angles, and
the image acquisition unit restructures an image of an inside of the inspection target on a basis of a plurality of images that are obtained by performing imaging plural times.

4. The nondestructive inspection apparatus according to claim 1, wherein
the radiation source includes a first radiation source and a second radiation source.

5. A nondestructive inspection method that uses a nondestructive inspection apparatus including
a radiation source,
an imaging panel that detects a radiation emitted from the radiation source and transmitted through an inspection target, and
a shielding plate that is arranged so as to be overlapped with the imaging panel on a side opposite to a side facing the radiation source and shields the radiation emitted from the imaging panel, the method comprising
arranging the imaging panel and the shielding plate that are overlapped with each other and the radiation source with the inspection target interposed therebetween, wherein
at the arranging, the imaging panel and the shielding plate each of which has flexibility are further arranged so as to be curved along a curved surface of the inspection target.

6. The nondestructive inspection method according to claim 5, further comprising
imaging the inspection target by driving the radiation source and the imaging panel after the arranging.

7. The nondestructive inspection method according to claim 6, further comprising
rotating the radiation source, the imaging panel, and the shielding plate around a central axis of the inspection target after the imaging.

8. The nondestructive inspection method according to claim 6, wherein
the inspection target is a reinforced concrete structure in which a plurality of reinforcing bars are buried in a concrete, and
at the arranging, the radiation source is arranged so as to face a gap between the plurality of reinforcing bars.

9. The nondestructive inspection method according to claim 6, further comprising
relatively moving the radiation source, the imaging panel, and the shielding plate with respect to the inspection target in a major axis direction of the inspection target after the imaging, wherein
the arranging and the imaging are performed again after the relatively moving.

10. The nondestructive inspection method according to claim 9, wherein
at the relatively moving, the imaging panel is relatively moved with respect to the inspection target so as to be partially overlapped with an area of the inspection target, which is imaged by the imaging panel before the relative movement.
